(19) United States
(12) Patent Application Publication
(10) Pub. No.: US 2022/0361418 A1
(43) Pub. Date: Nov. 17, 2022

(54) GREENHOUSE AND METHOD FOR REGULATING LIGHT INTENSITY WITHIN AN ORGANIC GROW SPACE

(71) Applicant: Mark Stanton, Laytonville, CA (US)

(72) Inventor: Mark Stanton, Laytonville, CA (US)

(21) Appl. No.: 17/315,210

(22) Filed: May 7, 2021

(51) Int. Cl. A01G 9/16

(52) U.S. Cl. CPC A01G 9/16

(57) ABSTRACT

A greenhouse for isolating one or more grow spaces containing a plant or plants from outside elements includes a frame structure that seats a plurality of smart glass panels that are adjustable relative to a state of translucence from transparency to complete opacity via an operable control on a control panel or by an automated process routine, the nature of the adjustment based on sensor input processed against static data resident on the control panel.

CROSS-REFERENCE TO RELATED DOCUMENTS

[NA]

### BACKGROUND OF THE INVENTION

### 1. Field of the Invention

The present invention is in the field of agriculture and pertains particularly to methods and apparatus for regulating light intensity during different phases of plant growth.

### 2. Discussion of the State of the Art

In the field of agriculture, more particularly in an enclosed grow space, the importance of light, heat, and humidity maintained within the grow space cannot be understated. For a plant that produces an annual or semi-annual yield of fruit or flower, the combination of light, heat, and humidity, and the correct regulation thereof in the grow space is critical for producing the maximum possible yields at harvest time.

In a general sense plants grow in sequential growth stages from germination to a seedling phase, to a vegetative phase, to flowering phase, to a fruit production phase (if flower is not final product). For plants grown outdoors, for example, time of transplant or sowing is critical because there will be a reliance on the natural weather; however, light heat and humidity will be whatever is in the weather patterns for the time that the plants are growing before harvest, typically in the fall. The ability to control light, heat, and humidity is limited to watering and to the amount of shade that may be available or supplied by the grower.

To produce better yields, many growers prefer to grow plants indoors in a greenhouse-type environment whether it is indoors (converted room) or in a detached greenhouse that relies on sunlight passing through the green house ceiling and perimeter. A detached greenhouse typically is an enclosed structure wherein one may regulate light, heat, and humidity with the proper electronic devices and controls to operate them. For example, devices may include humidifiers, heaters, coolers, ventilators, misters, and scree or shade devices that may, from time to time, be placed over plants to temporarily block ambient light and/or ultra-violet rays.

More recently, various forms of photosensitive or electrochemical glass products have been developed to enable a light intensity threshold to activate a darkening of the glass so that less ultraviolet radiation may pass through the glass as well as a lower (smaller amount) intensity of light passing through. A product example of aforementioned glass forms are well-known photosensitive films used to coat glass and produce the darkening effect when light is more intense. In construction using glass units having two or more panes set in a frame, polymer or ploy-organic materials are available in the art that may be formed into a viscous layer that is centered between panes of glass coated with reactive films that may be electrified via contact leads or traces connected to frame and to wiring terminating at a switch or a control panel. These units may be referred to herein as smart glass.

Smart glass units may be switched back and forth from transparency (clear starting point) or translucency (a reduced grade of transparency starting point) to opacity or to a point light no longer passes through the window. Smart glass units are gaining ground in the construction industry, particularly commercial construction, to help control the ambient environment within a room or rooms in a building. Other benefits include use of smart glass as a privacy glass that may be rendered opaque by supplying current to the electric-film layer or layers from a switch like a wall switch, for example.

In the evolution of smart glass from inception to the current state in the art, one product has emerged that enables a user to vary the amount of light transmission through the glass beyond two obvious points being transparent light (light passes through) and opaque (not light passes through). This unit of smart glass known in the art includes a polymer dispersed liquid crystal (PDLC) layer of film sandwiched between two layers of glass and two layers of indium tin oxide (ITO) film. Additive layers like EVA films that reduce UVR and help insulate for sound may be included the aggregate encompassing the whole footprint of the glass panes.

An operator using a control device or a switch with a dimmer function may adjust the translucency of PDLC smart glass units on a graduating scale from transparent to opaque. Moreover, an operator may connect the switch to a timer to gain automatic dimming control over the smart glass window. The technology employs particles that assume a state of alignment to enable light to pass through and may assume a state of disarray blocking the light from passing through according to the exact state of misalignment across the footprint of the glass panes. The alignment and misalignment states are ordered by the ratio of positive to negative charge supplied to the smart glass unit through a contact in the frame connecting to conductive leads connecting to the ITO film layers which may be alternately electrified or electrified in tandem. The current in the ITO film layers orders the alignment states of the particles within the PDLC center layer.

Currently, the role of PDLC smart glass is limited in function to manual adjustment to improve instant function and timed adjustments, which is simply a repetitive cycle of adjustment. Therefore, limitations still exist in light of implementations relative to the desired benefits of the product that may be realized.

Therefore, what is clearly needed is a method and apparatus for regulating light intensity entering a grow space such that plants within the grow space experience the optimum light intensity throughout their growing cycle.

### BRIEF SUMMARY OF THE INVENTION

According to an embodiment of the present invention, a greenhouse is provided for growing plants and includes a frame structure defining an inner grow space, the frame structure comprising individual frame members assembled together, the frame members rectangular in cross section and including at least one frame opening disposed along the length thereof on at least one side thereof, the frame openings contained between the ends of the frame members, the frame members adapted to seat and seal smart glass panels isolating the inner grow space environment of the greenhouse from outside elements, a greenhouse controller mounted inside the greenhouse on one or more frame members or on a smart glass panel having a location in the frame structure convenient to a greenhouse operator, the greenhouse controller including a computer processing unit, a display, one or more human-operable controls and a power ingress port for receiving power from a power source, the greenhouse controller further including power and data ports connected by wire to two or more environmental sensors deployed within the inner grow space of the greenhouse and just outside of the greenhouse, the frame structure hosting electrical wiring connected to the smart glass panels and to the greenhouse controller, and a set of coded instructions residing on a non-transitory memory medium coupled to or residing in a dedicated state within the greenhouse controller, the instructions executable on the greenhouse controller causing the controller to monitor the environmental state of the inner grow space and to automatically adjust or to recommend a manual adjustment of the translucency state of all or some of the smart glass panels based on the implications of monitored environmental data relative to maintaining optimum health of the plants grown in the greenhouse.

In one embodiment, the smart glass panels are polymer disbursed liquid crystal (PDLC) panels. In a variation of the embodiment, the smart glass panels include two sheets of glass or of polymer. In a preferred embodiment, the smart glass panels are sealed units. In one embodiment, one of the human-operable controls is a dimmer switch or a slider switch enabling manual adjustment of the translucency of the smart glass panels. In one embodiment, one of the human-operable controls is a selector switch enabling selection between an automated mode of operation and a manual or semi-automatic mode of operation.

In one embodiment, the greenhouse controller is a network capable device. In one embodiment, the greenhouse controller is a Bluetooth™ capable device. In one embodiment, the environmental sensors include at least one adapted to measure humidity inside the grow space. In one embodiment, the environmental sensors include at least one adapted to measure temperature inside the grow space. In one embodiment, the environmental sensors include at least one adapted to measure ambient light outside of the green house. In one embodiment, the one or more environmental sensors include one adapted as a dual sensor measuring humidity and temperature.

In one embodiment, the power source to the controller is a solar power source, or an alternating current/direct current (AC/DC) power source. In one embodiment, the greenhouse controller further includes a backup rechargeable battery. In one embodiment, the greenhouse is adapted as a commercial greenhouse. In another embodiment, the greenhouse is adapted as a single or double plant greenhouse enclosure.

In one embodiment, the executable instructions are executed by powering on the controller. In one embodiment, the smart glass panels are divided into two or more groups each group separately adjustable to increase translucent toward a transparency state or to reduce translucency toward a state of opacity. In another embodiment using a single or double plant greenhouse enclosure, the greenhouse enclosure is adapted for use in an indoor growing space illuminated by artificial grow lighting. In a variation of the single or double plant enclosure, the greenhouse is adapted for integration into a power and control network with other like greenhouses.

### BRIEF DESCRIPTION OF THE SEVERAL VIEWS OF THE DRAWINGS

FIG. 1 is an overhead view of a greenhouse adapted with smart glass panels according to an embodiment of the present invention.

FIG. 2 is a front elevation view of the greenhouse of FIG. 1.

FIG. 3 is a block diagram representing a dual pane smart glass panel according to current art.

FIG. 4 is a block diagram depicting components of a smart glass controller according to an embodiment of the invention.

FIG. 5 is a block diagram depicting functional aspects of the SW of FIG. 1 according to an embodiment of the invention.

FIG. 6 is a process flow chart depicting steps for maintaining desired environmental settings within a smart glass greenhouse according to an embodiment of the present invention.

FIG. 7 is a process flow chart depicting the process of FIG. 6 modified to adjust predicatively according to a variation of the embodiment of FIG. 6.

FIG. 8A is an overhead perspective view of a smart glass enclosure adapted for a single plant according to another embodiment of the invention.

FIG. 8B is a front elevation view of the smart glass enclosure of FIG. 8A.

### DETAILED DESCRIPTION OF THE INVENTION

In various embodiments described in enabling detail herein, the inventor provides a unique greenhouse system and method for regulating environmental conditions within a grow space. A goal of the invention is to provide an apparatus that can be regulated in an automated manner to detect and mitigate environmental anomalies that may occur inside a greenhouse. Another goal of the invention is to provide an apparatus and method for environmental condition mitigation that may save costs relative to electric consumption of environmental conditioning devices like heaters, coolers, and humidifiers. A further goal of the invention is to provide an apparatus and method of use that may increase yield and quality of flowers in certain flowering plants. The present invention is described using the following examples, which may describe more than one relevant embodiment falling within the scope of the invention.

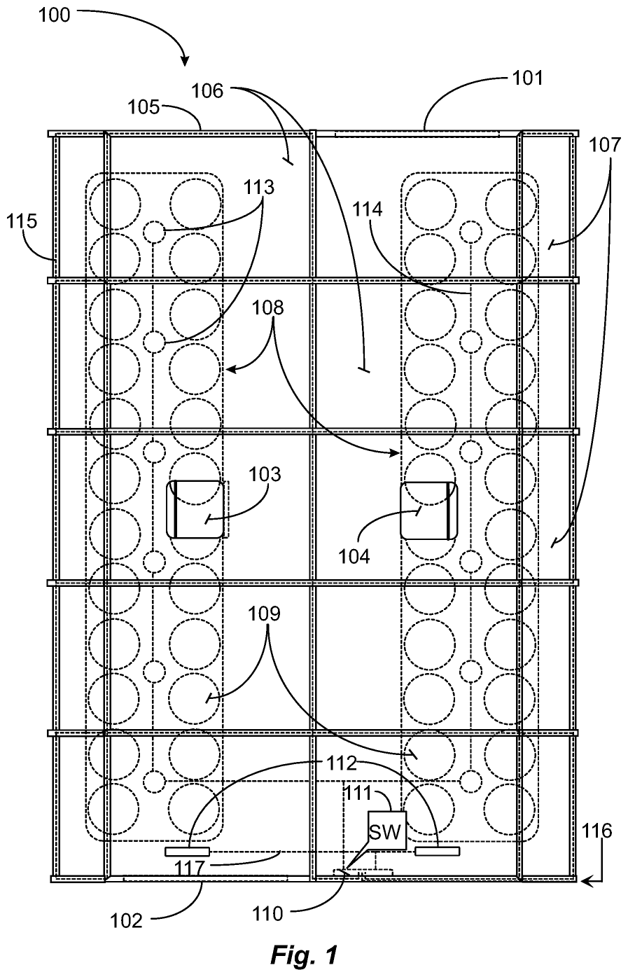

FIG. 1 is an overhead view of a greenhouse 100 adapted with smart glass panels according to an embodiment of the present invention. Greenhouse 100 includes a frame structure 105 supporting a number of stock or custom cut smart glass panels. Smart glass panels 106 are distributed to the top of frame structure 105. Smart glass panels 107 are distributed to the geometric sides of the frame structure 105. In this embodiment, greenhouse 100 is adapted to contain numerous plants represented herein as plants 109 depicted herein as annular pots (broken circles). Greenhouse 100 has a rectangular footprint in this example. A rectangular footprint for greenhouse 100 is not required in order to practice the invention.

Frame structure 105 may be assembled from smaller frame components and may be manufactured or otherwise fabricated of aluminum, UV resistant polymer materials, or other suitable rigid materials. In one embodiment, smart glass panels 106 and 107 are polymer dispersed liquid crystal (PDLC) panels including a central liquid crystal particle layer sandwiched between individual glass or polymer panels each having a mildly conductive iridium tin oxide (ITO) layer (not visible) containing particles dispersed uniformly over the most if not all of the footprint of the panel. In preferred embodiments, panels 106 and 107 are sealed units that seat inside a slot provided in the frame structure and may be seated in the frame structure in a manner that renders the structure watertight when fully assembled like a conventional window.

Greenhouse 100 has a rear panel door 101 and a front panel door 102 providing entryway into the greenhouse at opposing ends of the greenhouse. Greenhouse doors 101 and 102 may be hinged and framed and may open toward the outside of the greenhouse via door handles. Greenhouse doors 101 and 102 may be latched and/or locked closed when no one is operating inside the greenhouse. In a preferred embodiment, greenhouse doors 101 and 102 each support a smart glass panel that may function identically to all the other smart glass panels supported in the frame structure. In one embodiment the panels in greenhouse doors 101 and 102 are not smart glass panels but may be typical polymer UV resistive panels. In a variation of this embodiment, the panels in doors 101 and 102 are tinted dark using a tinting film or coating. In a further variation of the embodiment, there may be one door instead of two doors arranged on opposite ends of greenhouse 101.

One with skill in the art will recognize that smart glass panels like panels 106 and 107 are electrified to skew or to align the dispersed orientation of geometric micro-particles dispersed uniformly throughout the PDLC layer sandwiched in between the glass or polymer unit sheets. Therefore, frame structure 105 is adapted to carry an electric wiring 115 connected to a power source and may include strategically placed contact bus bars or leads that contact the respective ITO film layers on the glass or polymer sheets that interface the PDLC layer sandwiched there between. Electrical contacts for connecting to the window units may be provided along the length of wiring 115 and may be connected to one or more edges of a smart glass panel anywhere that the lead may contact the film.

Wiring 115 may terminate at a computer aided controller panel 110, referred to herein as a smart glass controller 110. Wiring 115 may form an open circuit that may be closed or opened and may be regulated relative to voltage delivered to the ITO films operating the PDLC layers. Controller 110 may be mounted in a convenient place in greenhouse 100 to frame or frame extension mount. Controller 110 may receive power from a source outside of greenhouse 100. In one embodiment controller 110 receives solar power from a solar system outside of greenhouse 100 through a power receptacle or ingress point 116. In another embodiment, controller 110 receives power from a power outlet that a power line terminating at the controller is plugged into.

Controller 110 may be a mini-computing device that may be operated manually to control the level of translucence of the smart glass panels 106 and 107 based on information that is available to the operator via other information sources, for example, temperature level readings and humidity level readings obtained through separate apparatus that might be utilized in greenhouse 100 to aid in maintaining a desired environment within the structure.

In this embodiment, greenhouse 100 is divided in terms of elongate grow spaces 108 orientated longitudinally in the footprint of the frame structure 105. A center isle is left between the grow spaces 108 to enable operators to service plants 109 arranged in the grow spaces on each side. In this embodiment, control panel 110 is adapted to receive and process data from a plurality of humidity sensors distributed linearly within each grow space 108 and serially connected by power feedback line 114 terminating at controller 110.

Humidity sensors 113 may each measure humidity and temperature in one embodiment for an area local to their installation. In this example, one sensor 113 is utilized to measure at least humidity level expressed as a percentage for four plants 109. Sensors 113 are therefore evenly spaced along the rows of plants 109 in each grow space 108. In this embodiment there are 12 sensors 113 for 48 plants represented herein by pots 109, also referred to simply as plants 109. In a preferred embodiment, controller 110 host and execute a set or sets of instruction by executing a software (SW) program 111 implemented on a non-transitory medium coupled to or otherwise contained in the controller.

SW 111 is adapted in a preferred embodiment to receive and process data received from humidity/temperature sensors 113 over sensor line 114 and to consider that data in light of local data available on the controller to recommend levels of adjustment of translucence in the smart glass panels 106 and 107. In one embodiment, greenhouse 100 further includes at least a pair of ambient light intensity sensors 112 provided on the top surface, in this embodiment, of smart glass panels 106. Light intensity sensors 112 may be adapted to record the intensity of sunlight directed against greenhouse 100. In one embodiment, light sensors 112 also sense temperature and humidity outside of greenhouse 100. Light sensors 112 are serially connected in this example by a power/feedback line 117 that terminates at controller 110. SW 111 is adapted in a preferred embodiment to receive and process data received from ambient light/humidity/temperature sensors 112 over sensor line 117 and to consider that data in light of local data available on the controller to recommend levels of adjustment of translucence in the smart glass panels 106 and 107.

Controller 110 may be adapted in one embodiment to display recommendations for adjusting the translucence of smart glass panels 106 and 107 based on data from humidity/temperature sensors 113, ambient light intensity/humidity/temperature sensors 112 and local data retained within the memory store of the controller unit 110. In one embodiment, controller 110 is enabled by SW 111 to automatically adjust the level of translucency of smart glass panels 106 and 107 in automation mode in conjunction with an on-board timing function where once the system is calibrated and powered on, the operator may switch to automated mode allowing the greenhouse controller to mitigate the internal environment of greenhouse 100 without operator involvement.

Greenhouse 100 includes one or more, in this case two vents 103 and 104 built into the opposing top smart glass panels 106. Vents 103 and 104 may be held open for better ventilation or held closed to prevent colder air from coming into the greenhouse. Vents like vents 103 and 104 may also be disposed in one or more side smart glass panels 107 without departing from the spirit and scope of the invention. In one embodiment, greenhouse 100 may have a fan-based ventilation system for producing some airflow within the greenhouse structure.

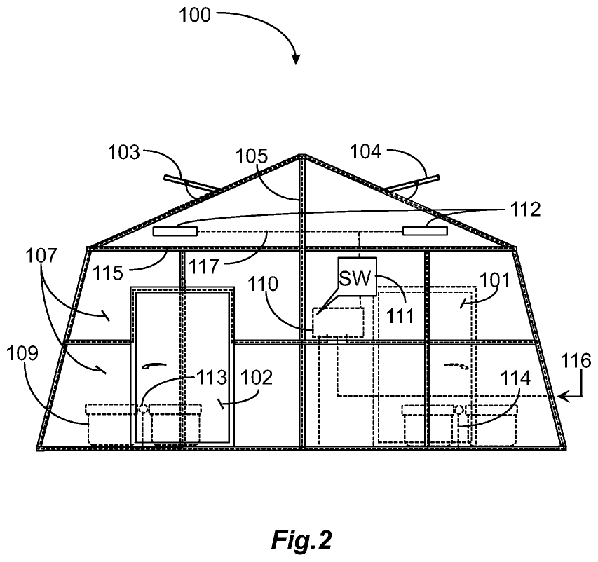

FIG. 2 is a front elevation view of greenhouse 100 of FIG. 1. Greenhouse 100 may be designed according to variant geometric footprints and may be scaled up or down in size without departing from the spirit and scope of the invention. Smart glass panels 106 (top) and 107 (side) may assume different geometric shape profiles according to the specifications of the frame structure.

Smart glass wiring 115 may be carried in all of the frame members of frame structure 105 or in a partial amount of a total amount of the frame members to illicit contact with all of the ITO films on the smart glass units. In this embodiment, humidity sensor power and feedback line 114 is largely routed in the floor or otherwise on the floor of greenhouse 100 and may be routed from humidity sensors 113 up a frame 105 or side smart glass panel 107 to connect with controller 110 from the bottom of the unit. Ambient light intensity sensor power and feedback 117 from light sensors 112 may be routed in a ceiling frame portion or along the underside of the top smart glass panels 106 (FIG. 1) and then down a side panel 107 and connected to controller 110 from the top.

Power receptacle or ingress point 116 may be elevated off of ground level and routed along the inside of side panels 107, then up into controller 110 from the bottom. Both vents 103 and 104 are held open in this embodiment. Likewise, green house doors 101 and 102 may also be held open to aid in aerating or otherwise ventilating greenhouse 100 along with the open greenhouse doors. Greenhouse 100 is typically tall enough to house very tall plants 109 and may be assembled as a commercial greenhouse structure, as a much scaled down structure like home/garden greenhouse structure, or even as a tiny greenhouse structure adapted to cover one or more plants.

In one embodiment, controller 110 includes output connector ports that may be used to provide power and command lines to other greenhouse accessory devices like fans, a humidifier, a heater, or a ventilator system without departing from the spirit and scope of the present invention. In this embodiment, controller 110 may make smart glass adjustments relative to smart glass translucency and may also command connected devices mentioned above to perform various cycles to help maintain an optimum greenhouse environment like starting a ventilation cycle and maintaining that cycle over time, or starting a humidification cycle and maintaining that cycle over time. In one embodiment, controller 110 may also be connected to a cycle module for misters or plant watering systems. In such cases, SW 111 may be adapted with additional instruction for controlling accessory devices and systems that are connected to the controller.

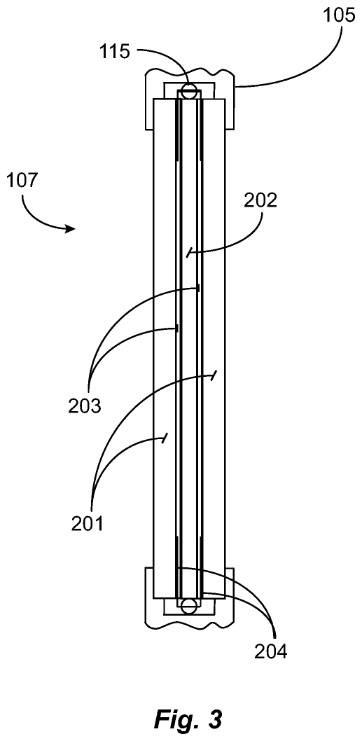

FIG. 3 is a block diagram representing a dual pane smart glass panel according to current art. In this view, the block diagram may represent a smart glass side panel like panels 106 (FIG. 1) or panels 107 described further above in FIG. 1 and in FIG. 2. Smart glass unit 107 includes two transparent sheets 201 of glass or polyurethane spaced apart with a gap there between filled by a PDLC layer 202 containing the geometric particles dispersed evenly throughout the latter. Two ITO film layers 203 are disposed on the PDLC interfacing sides of the glass or polymer sheets of unit 107.

Frame 105 may be formed to seat the smart glass units and may be adapted to seal against the material of the sheets 201 to protect frame elements and the interior of the greenhouse from rainwater and from leaking or other potential elements that may otherwise enter the greenhouse. Wire 115 may support bar or lead contacts 204 that may be included in the fabrication of individual smart glass units and connected to wire 115 within the confines of frame 106. In this view, there are contacts 204 contacting ITO film layers 203 on opposing edges of unit 107. This particular arrangement may not be required in order to practice the present invention. Unit 107 may include a slight vacuum in between sheets 201 of the unit and sheets 201 may include other films or layers deposited on the outside surfaces to resist solar radiation or to help insulate the unit against excessive heat or cold. In a preferred embodiment of the invention, the sheets 201 of unit 107 are by default transparent and clear and are adjusted over time of operation to become less translucent to completely opaque according to need perceived by controller 110 monitoring various sensors inside and outside of the structure.

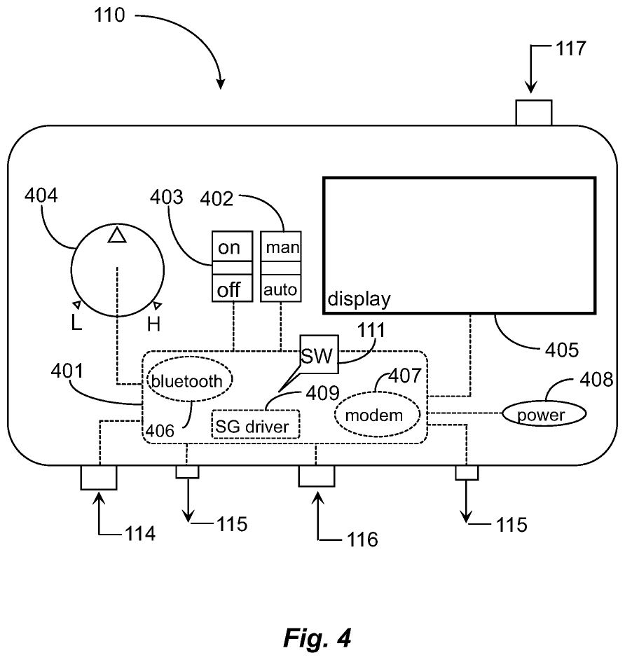

FIG. 4 is a block diagram depicting components of smart glass controller 110 of FIG. 1 according to an embodiment of the invention. Smart glass controller 110 may be adapted as a computing device including presence of a computer processing unit (CPU) 401. CPU 401 may include memory and memory controllers (not illustrated) and may include a smart glass (SG) driver 409 for regulating voltage to the smart glass units 106 and 107 of FIG. 1. SW 111 may be executed to run when CPU 401 is booted up.

CPU 401 may include a display device 405 for displaying data such as sensor readings, sensor reading average values, percentages of opacity or translucency of smart glass units, and/or any recommendations made by the system to an operator relative to manual control of separate devices used within the greenhouse structure. Display 405 may be a liquid crystal display, a light emitting diode (LED) display, an organic light emitting diode (OLED) display, or another type display without departing from the spirit and scope of the present invention. In one embodiment display 405 is a touch screen that may be manipulated by an operator as a data input device. In one embodiment, controller 110 may include a keypad or small keyboard (not illustrated) in this example.

CPU 401 may support a manual dimmer switch 404 that may be manipulated by an operator to change the translucency of the smart glass units from high transparency (H) to complete opacity (L). In a manual mode, display 405 may provide recommendations to an operator to make a manual adjustment using dimmer switch 404. In one embodiment switch 404 may be a linear slider switch. SG driver 409 may regulate the amount of voltage and polarity of the voltage recommended by SW 111 in an automated mode that bypasses manual operation.

Controller 110 receives data from humidity/temperature sensor input 114, and from ambient light intensity/humidity/temperature sensor input 117. The interfaces may be in the form of plug-in connectors. In one embodiment, controller 110 includes a rechargeable battery (not illustrated) that may assume control over the unit in the event of a power outage. In one embodiment, a power button 408 is provided to boot CPU 401 triggering SW 111 to execute to a run state.

Controller 110 includes a power in port for power line 116 and two voltage distribution ports to SG wiring 115 to activate the SG units 106 and 107 introduced in FIG. 1 and in FIG. 2. CPU 401 may support a manual selector switch 403 (ON/OFF) that may be manipulated by an operator to override automated settings to turn SG units fully transparent (ON) or fully opaque (OFF) bypassing or overriding intermediate levels of adjustment made by switch 404 or via automation through SG driver 409. In one embodiment, CPU 401 supports a manual selector switch 402 that enables the operator to select between manual mode (man) and automatic mode (auto).

In one embodiment, controller 110 may be network capable wherein CPU 401 supports a modem 407 for connecting to a data network and a Bluetooth™ module 406 (chip set) for enabling communication with another Bluetooth™ enabled device like an operator's cellular device or one or more greenhouse accessory devices powered separately but controlled by controller 110 through commands transmitted wirelessly through Bluetooth™ wireless technology. Controller 110 may include a component cooling fan and vents (not illustrated) as are typical for CPU processors.

In one embodiment, in automatic mode, controller 110 may access a server and retrieve local weather data predicted for a period of days and nights and which may include hourly predictions of temperature, precipitation, cloud cover, and humidity in the air outside of greenhouse 100. CPU 401 is assumed to have an internal clock that may display the correct time and date, and, wherein, controller 110 performs tasks in automatic mode in synchronization with the time. In one embodiment, an operator may program or otherwise input data into controller 110 using a network connection or a Bluetooth™ connection.

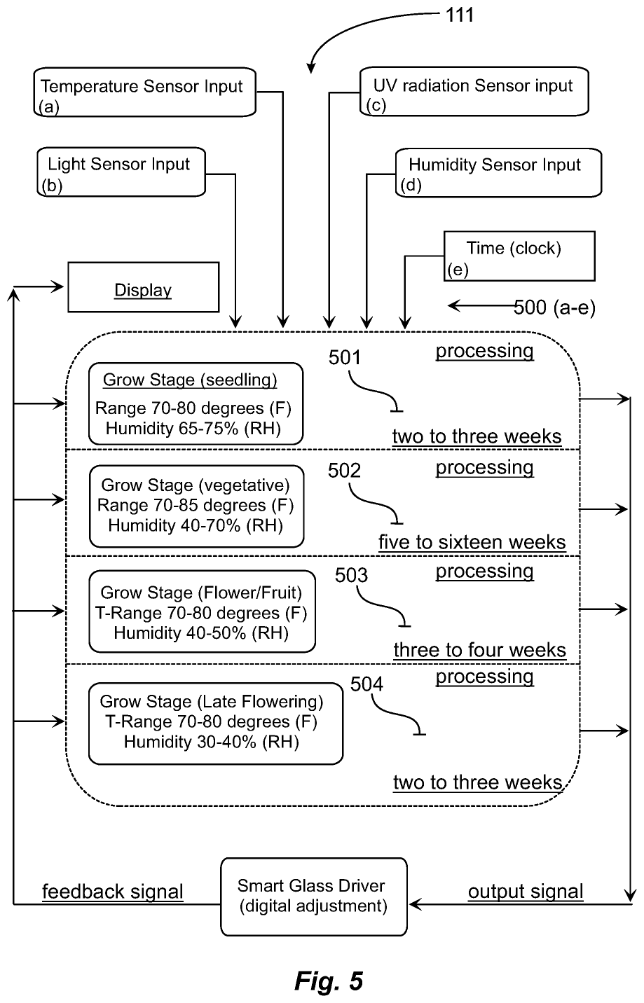

FIG. 5 is a block diagram depicting functional aspects of the SW of FIG. 1 according to an embodiment of the invention. SW 111 is in a preferred embodiment, adapted to process data and make recommendations that may vary somewhat across more than one stage of plant growth of from one growth stage into the next growth stage. In this embodiment, SW 111 includes four separate data processing stages or layers 501 through 504. Growth stages 501 through 504 include static data that may be input into controller 110 to access CPU accessible memory; the nature of which may depend entirely on the type and even the strain of plants grown. For example, in cannabis plant species of indica and species of sativa strains the hybrids of both species may have quite different growth stages relative to time in stage, temperature requirements, humidity requirements, and light intensity levels recommended for each stage.

In this particular instance, there are four data processing layers 501, 502, 503, and 504 that are mapped to or are associated with static data sets that are provided and verified as important or required as attainable values relative to each growth stage of a known strain and species of cannabis plant. Processing layer 501 references a two-to-three-week seedling growth stage for a cannabis plant seedling of a known strain and species being grown in greenhouse 100. During the seedling stage, the plants need more humidity than the subsequent stages, approximately 65% to 75% relative humidity throughout the two-to-three weeks of time allotted at an average temperature range of 70 degrees to 80 degrees Fahrenheit (F).

Processing layer 502 refers to the same plant and reveals the average time (static data) of five to sixteen weeks for a vegetative growth stage of the plant. Static data indicates that the vegetative growth stage of the plant requires a slightly higher allowance for temperature within the greenhouse (70 to 85) degrees Fahrenheit and significantly less humidity. Processing layer 503 is associated with a flowering growth stage of the same plant allotted three to four weeks at a temperature range between 70 and 80 degrees F. and a reduction of the high humidity range from 70 percent RH down to 50 percent RH. Processing stage 504 is associated with a late flowering growth stage including a duration of two-to-three weeks, a temperature range of 70 to 80 degrees, and a humidity level at 30 to 40 percent RH. The static data for each growth stage may be entered into controller 110 and associated with appropriate processing layers of SW 111. the four processing layers of SW 111.

It is important to note that the static data for each growth stage may be different for different plants being grown in greenhouse 100, and, in the event of more than one strain and/or species being grown together in a same grow space, the static data may be updated to reflect common averages of time duration of stage, temperature of stage, and humidity level during the stage.

SW 111 may execute the processing layer 501 for the expected period of time for the growth stage for a seedling and may use the incoming sensor data during the stage duration to justify automated smart glass unit adjustments or provide recommendations to operators throughout the instant stage to attempt to maintain ideal conditions listed in the static growth stage information for the plant at that stage. Each subsequent processing layer 502, 503, and 504 may be executed and may map to the appropriate growth stage data when the appropriate time arrives for that growth stage during the overall growing season of the plants. In another embodiment only one data processing routing is running but accesses the appropriate growth stage static data as a weight factor when mitigating the environment within the greenhouse.

Keeping in mind that growth stage data for certain plant types like cannabis may be approximate given plant type, species, and/or goals of the operator relative to harvesting, controller 110 aided by SW 111 may from time to time be manually adjusted overriding an automatic setting. For example, if solar apex light penetrating the greenhouse is more intense over a period than what was predicted or that just occurred as a weather anomaly deviating from normal light intensity, controller 110 may adjust SG units to increase opacity while also sending a commend to add a ventilation cycle or cooling cycle to reduce temperature and, therefore, humidity level given the same amount of water delivered to the plants. If on the other hand a period of dark sky ensues giving low light conditions and lower temperatures then predicted or expected controller 110 may adjust the SG units to maximum transparency, start a heating cycle (accessory), and/or raise humidity along with temperature.

In one embodiment wherein controller 110 has no automated control over greenhouse accessory devices like a heater, a humidifier, or a ventilator circulation system, recommendations for adjusting the levels of those systems or devices may be provided on display to an operator or, in one embodiment, through a notification to the operator's Bluetooth™ connected cell phone. In one embodiment, controller 110 aided by SW 111 may plan SG settings over a time period based on a weather prediction for each 24-hour period within the time period. In this embodiment, adjustments may still be made when weather patterns do not conform to the predictive data for any period of time covered by the predictive data.

Other data that may be static on controller 110 may include greenhouse size data including volume data within the structure relative to the amount of cubic space making up the controlled environment within the structure. In one embodiment, controller 110 may have static data relative to a cure stage or drying stage for harvested plants that may include suggested time, suggested humidity, and suggested light intensity levels wherein controller 110 aided by SW 111 may adjust SG translucency levels more favorable to curing such as maintaining complete opacity of the SG units or adjusting them accordingly based on actual temperature and humidity levels.

SW 111 relies on receiving and analyzing data monitoring inputs 500 (a-e) that may include temperature sensor input 500 (a) measured within and outside the greenhouse structure; light intensity sensor input 500 (b) measured within and outside the greenhouse structure; UV radiation intensity input 500 (c) measured within the structure; humidity sensor input 500 (d) measured within the structure; and time input 500 (e) provided by internal clock. SW 111 may send a feedback signal to each processing stage wherein the data includes the current temperature and humidity levels, and current SG adjustment level.

In one embodiment, more granularity in adjusting SG units may be obtained by adding a channel bridge that may divide the total number of SG units into separate groups that might be adjusted separately by the system. For example, the top units comprising the roof may be designated to one group and adjusted to a different level of translucence than the units making up the side units, which may be designated to another group. The total number of SG units may also be divided into four groups, for example, based on which direction N, S, E, or W they are facing predominantly. In such an embodiment, controller 110 aided by SW 111 may process data differently for each designated group and may adjust the translucency of units in a same group at different levels than in another group.

SW 111 receives inputs via controller monitoring activity and process the input data in light of static on board data like growth stage data and then decides whether an SG unit adjustment should be made. Output from this process includes the adjustment data input into the smart glass driver which controls the amount of current and polarity of current that enters the ITO films in the SG units. The output data may include data generated by controller 110 for display to an operator and in messaging or notifications sent to the operator's Bluetooth™ connected device received by the operator when in range of the controller. In one embodiment, an operator may have a greenhouse SW client application running on his or her electronic device to help manage data and to enable override adjustment by communicating to the controller through the application.

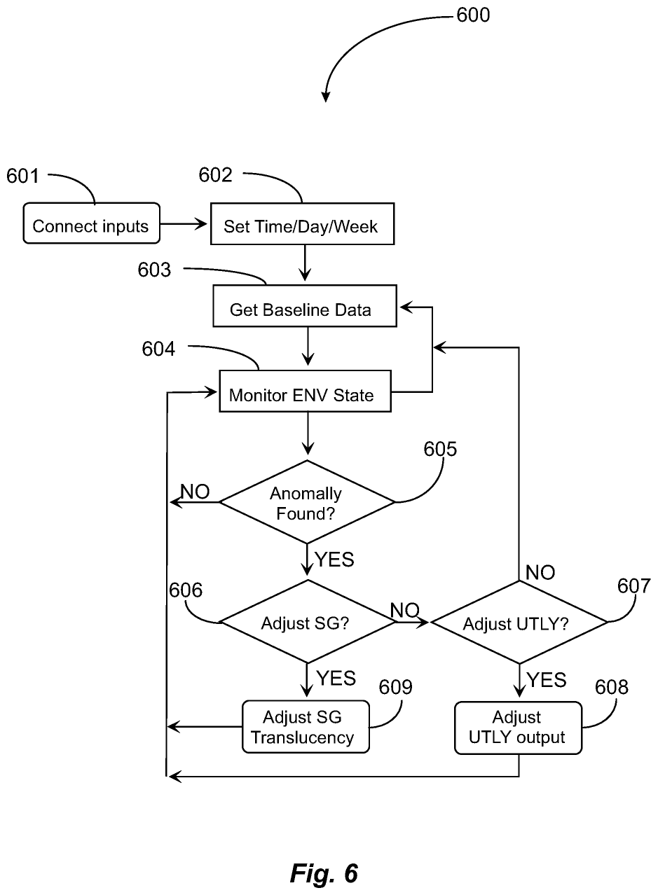

FIG. 6 is a process flow chart 600 depicting steps for maintaining desired environmental settings within a smart glass greenhouse according to an embodiment of the present invention. In step 601, an operator of an assembled greenhouse like greenhouse 100 connects the inputs from deployed sensors into the powered-on controller panel of the system. At step 602, the operator may set the correct time, day, and week (if applicable) at the controller. In one embodiment, an internal clock is set correctly at the controller through a touch screen display on the controller or through a connectable keyboard that may be used to input data into the controller.

At step 603, the controller may get baseline data from the sensors, and the operator may enter data into the controller that serves as static reference information for the controller during processing like growth stage data, types of and number of plants being grown in the grow space, etc. At step 604, the controller may monitor the environmental state within and/or outside the greenhouse structure. Status monitoring may be continual or may be periodic without departing from the spirit and scope of the invention. In some instances, during a growth stage transition, the controller may retrieve a different set of baseline data, or, if changes are made in number of plants or types of plants, new baseline data may be added for any growth stage.

At step 605, the system looks for anomalies reported by sensor data that conflict with suggested baseline data or that might lead to skewing of actual environmental conditions expected within the structure. An anomaly may be detection of a higher temperature or humidity level than is suggested in range data in the growth stage data for a current growth stage. At this step, the system identifies the anomaly (when detected) before taking any actions. If, at step 605, no anomaly is detected, the process may loop back to monitoring the environmental state of the greenhouse. It is noted herein that sensor input may come from sensors deployed both within and outside of the greenhouse structure.

If an anomaly is detected at step 605 the process moves forward to step 606 at which time the controller aided by SW 111 decides if SG unit translucency level should be adjusted toward transparency or toward opacity to aid in mitigating the anomaly detected. In this step 606, the controller aided by SW 111 may determine the amount of adjustment if one is recommended. If at step 606 the determination is that the anomaly is not sufficient to make an adjustment, the controller may decide at step 607 whether to make an adjustment to a system connected utility under control of the controller like a humidifying unit, a heating unit, or a ventilation or air circulating unit. Step 607 is not required if no utilities are controlled by the controller and SW 111.

If the system decides not to make an adjustment to a utility in step 607, the process loops back to step 603 and then step 604 (monitoring ENV state). If at step 606 the controller aided by SW determines to make an SG adjustment, then the controller adjusts the translucency state of the SG units at step 609. The controller (if adapted) may also make a utility adjustment at step 608 if the determination to do so is made at step 607; any of the following may occur: the controller may only adjust the SG units but not the output of one or more connected utilities, or the controller may adjust the SG units and one or more connected utilities, or the controller may adjust one or more connected utilities but not the SG units.

It is noted herein that in manual mode, the determination may still be made by the SG controller wherein one or more recommendations for adjustment and adjustment amounts for the SG units and any connected utilities are published to display on the controller panel for operator view and/or sent to a BT connected device operated by someone charged with making manual adjustments to the system. This would be a semi-automatic embodiment. After all activity relative to adjusting, the process by default loops back to the monitoring state and recycles the steps for each anomaly that may be detected.

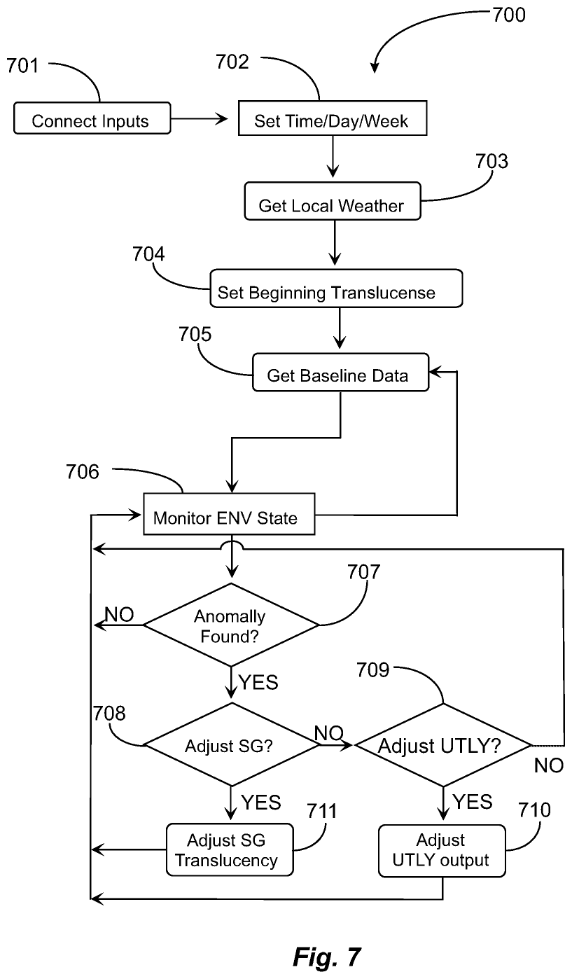

FIG. 7 is a process flow chart 700 depicting the process of FIG. 6 modified to adjust predicatively according to a variation of the embodiment of FIG. 6. In this process, steps 701 and 702 are analogous to steps 601 and 602 of FIG. 6. At step 703, the controller aided by SW may access a weather prediction in the form of a weather report for a period of time like a week or 10 days where the data may break the prediction down to the hourly data predicted in the report. At step 704, an optional step of setting beginning translucence level for the SG units may be undertaken by the controller. This step may also be optionally added to step 604 of FIG. 6. Otherwise, the base or beginning setting for the smart glass is by default transparent and is not changed until environmental state monitoring within the structure is undertaken; moreover, this monitoring step may require some period of time before any adjustments may be made to ensure the internal environment has reached stability.

Steps 705 through 711 in this process are analogous with steps 603 through 609 of FIG. 6 of the same descriptions. The predictive weather data may help the controller aided by SW 111 to define an adjustment plan based on predicted conditions whereas adjustments may be scheduled accordingly over the period predicted. Anomalies detected by the system that deviate from the predicted pattern may force additional adjustments that were not part of the schedule of planned adjustments.

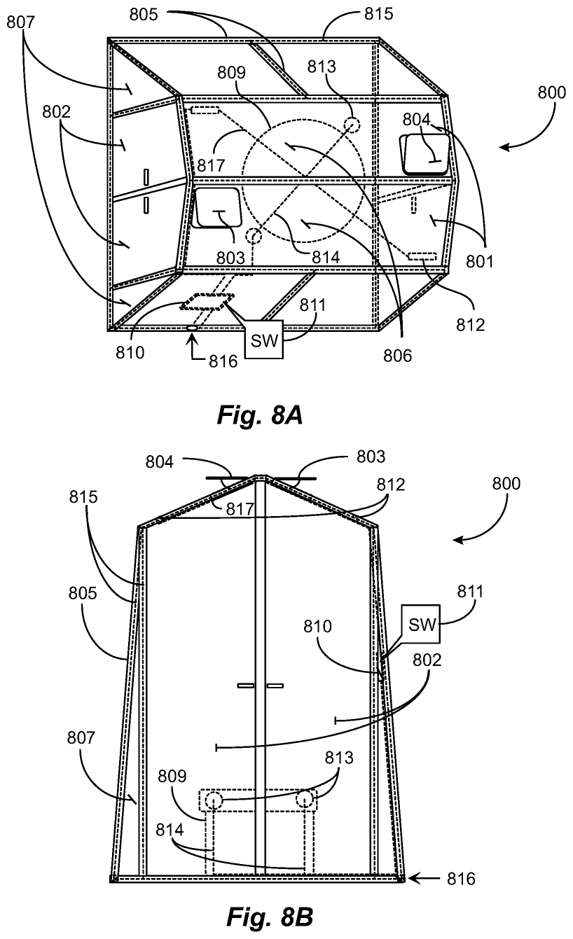

FIG. 8A is an overhead perspective view of a smart glass enclosure 800 adapted for a single plant or more plants according to another embodiment of the invention. FIG. 8B is a front elevation view of the smart glass enclosure of FIG. 8A. Referring now to FIG. 8A, greenhouse structure 800 is a smaller scaled down version of greenhouse structure 100 and include all of the same elements, the element numbers corresponding with those in FIG. 1 and in FIG. 2. Enclosure 800 includes rear panel doors 801 analogous to rear panel doors 101 in FIG. 1. Enclosure 800 includes front door panels 802 analogous to front door panels 102 in FIG. 1. Enclosure 800 includes two vents 803 and 804, which are analogous to vents 103 and 104 described with reference to FIG. 1. Enclosure 800 includes a frame structure 805 analogous to frame structure 105 of FIG. 1. Enclosure 800 includes top smart glass panels 806, which are analogous to top smart glass panels 106 described in FIG. 1. Enclosure 800 includes side smart glass panels 807 analogous to side smart glass panels 107 of FIG. 1.

Enclosure 800 includes at least one plant 809, which is analogous to plants 109 described in FIG. 1. Enclosure 800 includes a computer aided controller panel 810 analogous to controller panel 110 introduced in FIG. 1. Controller panel 810 may host SW 811, which is analogous in description and function to SW 111 of FIG. 1. In this embodiment, enclosure 800 includes a pair of ambient light sensors 812 analogous in function and description to ambient light sensors 112 of FIG. 1. Enclosure 800 includes at least two humidity/temperature sensors 813, which are analogous to the humidity/temperature sensors 113 introduced in the description of FIG. 1 above. Enclosure 800 further includes power feedback lines 814 analogous to lines 114 introduced in FIG. 1, which in this embodiment are connected to humidity/temperature sensors 813 and terminating at controller 810.

Enclosure 800 includes electric wiring 815 carried within frame structure 805 in the same manner as electric wiring 115 of FIG. 1 carried within frame structure 105 as described above in the description of FIG. 1. In one embodiment, enclosure 800 includes a power receptacle ingress point 816, which is analogous to power receptacle ingress point 116 described in FIG. 1. In this embodiment, like that of FIG. 1, enclosure 800 includes a power/feedback line 817 (analogous to line 177, FIG. 1) to connect ambient light sensors 812 to controller 810. In this embodiment, the greenhouse is simply an exceedingly small enclosure, which may be a smaller version of the greenhouse of FIG. 1 that may be placed outdoors over a plant or plants in the ground or in planter pots.

Referring now to FIG. 8B, the enclosure 800 requires minimal sensor deployment and utility support because of the much smaller cubic volume of air within the enclosure. In this view of the front side, doors 802 are visible as well as side panels 807. Power receptacle ingress point 816 enters the enclosure from the left side, but may be constructed to enter the enclosure from any desired point without departing from the spirit and scope of the invention. Other visible components in this view include the frame structure 805, the main wiring 815, the plant 809, the humidity/temperature sensors 813, the line from the sensors to the controller 814, and the ambient light sensors 812. Essentially, enclosure 800 is represented herein as a miniature version of enclosure 100 introduced and described in FIG. 1 above. However, that should not be construed as a limitation of the embodiment. Greenhouse enclosures such as enclosure 100 and enclosure 800 may be provided in scaled up versions for commercial growing or scaled down versions for small consumer operations without departing from the spirit and scope of the present invention.

In one embodiment, an operator may plant 6 plants in the ground, for example, 6 cannabis plants and may place one enclosure 800 over each plant. In this embodiment, power from a solar power source or an AC/DC power source may be supplied to a first enclosure and then to the other enclosures serially similar to light bulbs on a string of light bulbs. Also in one embodiment, multiple enclosures may be connected together by air ducting controlled by an air circulation system so that the air in each enclosure may be cycled through all of the connected enclosures. In a further embodiment, a small number of these individual enclosures may be monitored and adjusted (SG units) by a single greenhouse controller with an adjustment capability for individually adjusting the SG glass or polymer units of each enclosure separately depending on data received by sensors deployed within and local to each individual structure.

Other benefits of using smaller scaled down greenhouse structures may be evident in that individual structures may be removed from a network of such structures, for example, if a plant or plants are harvested from one structure and the structure is no longer required to be connected to the network of structures. These individual units may also be used to test different lighting and indoor climate combinations to help determine optimal growth comparisons for future baseline data and monitoring during growth stages. In one embodiment, such structures, and the general operation of those may be practiced indoors in a grow room that uses grow lights instead of relying on outdoor sunlight. In such a case, the singular enclosures may only require occasional SG unit adjusting based on the grow light intensity for that particular structure within the indoor grow space whereas overall humidity and temperature may be better controlled by a unit that controls the overall environmental conditions humidity and temperature in the room rather than within the individual structures.

It will be apparent to a person with skill in the art that smart glass greenhouse system of the present invention may be provided using some or using all the elements described herein. The arrangement of elements and functionality of the invention is described in different embodiments, each of which is considered an implementation of the present invention. While the uses and methods are described in enabling detail herein, it is to be noted that many alterations could be made in details of the construction and the arrangement of the elements without departing from the spirit and scope of this invention. The present invention is limited only by the breadth of the claims below.

1. A greenhouse for growing plants comprising:
a frame structure defining an inner grow space, the frame structure comprising individual frame members assembled together, including at least one frame opening disposed along the length thereof on at least one side thereof, the frame openings contained between the ends of the frame members, the frame members adapted to seat and seal smart glass panels isolating the inner grow space environment of the greenhouse from outside elements;
a greenhouse controller having a location in the frame structure, the greenhouse controller including a computer processing unit, a display, one or more controls and a power ingress port for receiving power from a power source, the greenhouse controller further including power and data ports connected to two or more environmental sensors deployed within the inner grow space of the greenhouse and outside of the greenhouse, the frame structure hosting electrical wiring connected to the smart glass panels and to the greenhouse controller; and
a set of coded instructions residing on a non-transitory memory medium coupled to or residing in a dedicated state within the greenhouse controller, the instructions executable on the greenhouse controller causing the controller to monitor the environmental state of the inner grow space and to automatically adjust and to recommend a manual adjustment of the translucency state of all or some of the smart glass panels based on the monitored environmental data relative to maintaining optimum growth of the plants grown in the greenhouse.

2. The greenhouse of claim 1, wherein the smart glass panels are polymer disbursed liquid crystal (PDLC) panels.

3. The greenhouse of claim 2, wherein the smart glass panels include two sheets of glass or of polymer.

4. The greenhouse of claim 3, wherein the smart glass panels are sealed units.

5. The greenhouse of claim 1, wherein one of the human-operable controls includes any one of a dimmer switch and a slider switch enabling manual adjustment of the translucency of the smart glass panels.

6. The greenhouse of claim 1, wherein one of the human-operable controls is a selector switch enabling selection between an automated mode of operation and a manual mode of operation.

7. The greenhouse of claim 1, wherein the greenhouse controller is a communication network connectable device.

8. The greenhouse of claim 7, wherein the greenhouse controller is a Bluetooth™ capable device.

9. The greenhouse of claim 1, wherein the environmental sensors include at least one adapted for measuring temperature inside the grow space.

10. The greenhouse of claim 1, wherein the environmental sensors include at least one adapted to measure ambient light outside of the green house and inside of the greenhouse.

11. The greenhouse of claim 1, wherein the smart glass panels are divided into two or more groups each group separately adjustable to increase translucency toward a transparency state or to reduce translucency toward a state of opacity.

12. The greenhouse of claim 1, wherein the greenhouse may be integrated into a communication and control network with other like greenhouses.

13. The greenhouse of claim 1, wherein the greenhouse is a single or double plant greenhouse enclosure.

14. A method for controlling vegetative growth and flower growth in plants cultivated in a greenhouse, comprising the steps of:
providing a plurality of frame members formed in walls and a roof forming the greenhouse, the frame members adapted to seat and seal smart glass panels isolating the inner grow space environment of the greenhouse from outside elements;
determining a growth time period and flowering time period cycle for the flowering plants housed within the greenhouse;
determining ambient light within the greenhouse and outside the greenhouse via lighting sensors; and
controlling opacity of the smart glass from complete translucency to complete opacity blocking all ambient light, with a controller connected to and regulating an electric current to each of the frame members;
regulating and manipulating the growth time period and flowering time period via the controller controlling the opacity of the smart glass according to the ambient light detected within and outside of the greenhouse.

15. The method of claim 14, wherein the controller automatically controls the smart glass via software according to the growth time periods and flowering time periods.

16. The method of claim 14, wherein the power source to the controller is a solar power source.

17. The method of claim 14, wherein the greenhouse controller further includes a backup power source other than solar.
